(19) United States
(12) Patent Application Publication
(10) Pub. No.: US 2024/0030483 A1
(43) Pub. Date: Jan. 25, 2024

(54) CELL ASSEMBLY AND ALL SOLID-STATE BATTERY COMPRISING THE SAME

(71) Applicant: Factorial Inc., Woburn, MA (US)

(72) Inventors: Jun Lee, Seoul (KR); Hosang Park, Winchester, MA (US); Toshinori Sugimoto, Woburn, MA (US); Hyun Seok Kim, Lexington, MA (US); Jae Myung Lee, Belmont, MA (US)

(21) Appl. No.: 18/350,861

(22) Filed: Jul. 12, 2023

Related U.S. Application Data
(60) Provisional application No. 63/391,365, filed on Jul. 22, 2022.

(51) Int. Cl. H01M 10/04; H01M 50/103; H01M 50/119; H01M 50/15; H01M 50/474; H01M 50/494

(52) U.S. Cl. CPC H01M 10/0481; H01M 50/103; H01M 50/119; H01M 50/15; H01M 50/474; H01M 50/494

(57) ABSTRACT

Disclosed is a prismatic cell assembly, comprising a housing, a stacked sheets (or layers) comprising electrode and solid electrolyte, and a pre-deformed elastic body placed on the top or bottom of or sandwiched within the stacked sheets, wherein the compressed or deformed elastic body exerts an internal compression among the stacked sheets. In one embodiment, the housing is formed by welding a first plate and a second plate. In one embodiment, the cell assembly exhibits an improved electrochemical performance and longer lifetime.

### CROSS-REFERENCE

This disclosure claims benefits of U.S. Application No. 63/391,365 filed Jul. 22, 2022, the entire contents of which is hereby incorporated by reference in its entirety.

### FIELD OF THE DISCLOSURE

This disclosure relates to a prismatic cell assembly or structure related to all solid-state battery and method therefor.

### BACKGROUND OF THE DISCLOSURE

Lithium-ion battery cells can be primarily divided into three form factors, i.e., cylindrical, pouch, and prismatic. In general, prismatic cell assemblies have a number of layered stacks of electrodes, electrolytes and separators that are first placed into a hard-case housing followed by injecting liquid electrolytes and sealing the filled hard-case housing. Such conventional design and process for a prismatic cell imposes a great challenge to solid state electrolytes whose properties are significantly different from the liquid ones. For example, the volume of the cathode in all solid-state batteries such as sulfide solid-state battery generally changes during operation. As shown in FIG. 1, an electrode/electrolyte sheet(s) (300) (other components not shown) are placed within a battery case (200) sealed with a lid assembly (100). A gap between the sheets (300) and the inner wall of the case (200) is reserved to accommodate the volume change. A battery comprising such a gap has a lower energy density due to the existence of the gap. Therefore, the electrochemical performance of solid-state battery from the conventional assembly is far from ideal. Furthermore, when the gap is filled up under some circumstances, it may be beyond the design thickness range, causing potential safety issues. A new cell assembly is highly desired for a prismatic cell comprising solid-state electrolytes.

### SUMMARY

Disclosed is a prismatic cell assembly (and method of making the same) that eliminates or minimizes the gap present in prior designs and provides compression to the solid electrolyte and electrodes of the cell in the form of an elastic body that is pre-deformed during manufacture of the cell. The pre-deformed elastic body provides compression to the solid electrolyte and electrodes, thereby reducing contact resistance among the solid electrolyte and electrodes and increasing the electrochemical performance of the cell. In particular, the present disclosure provides a new cell assembly for all solid-state prismatic cell, comprising a housing (alternatively, case or battery case); one or more stacks of sheets (or layers) each stack comprising an electrode layer and a solid-state electrolyte layer; and a pre-deformed elastic body positioned within the housing (for example, placed between the internal wall of the housing and the top or bottom of one of the stacked sheets or sandwiched within the stacked sheets), wherein the pre-deformed elastic body exerts an internal compression on or among the stacks without the application of external forces on the housing post-manufacture of the prismatic cell assembly. In one embodiment, the housing is formed by welding a first plate and a second plate. In one embodiment, the housing is a hard-case housing. In one embodiment, the cell assembly exhibits an improved electrochemical performance and longer lifetime.

### BRIEF DESCRIPTION OF THE FIGURES

FIG. 1 shows a cross section view of a cell assembly in a prior art.

FIG. 2A shows an overview of a representative cell after assembly according to one embodiment of the present disclosure.

FIG. 2B shows a cross section view of a representative cell after assembly according to one embodiment of the present disclosure.

FIG. 2C shows a cell assembly according to another embodiment of the present disclosure.

FIG. 2D shows a cross section view of a cell assembly according to one embodiment of the present disclosure.

FIG. 2E shows a cross section view of a cell assembly according to one embodiment of the present disclosure.

FIG. 3A is an exploded view of a representative top-terminal cell assembly with key components according to one embodiment of the present disclosure.

FIG. 3B is an exploded view of a representative side-terminal cell assembly according to one embodiment of the present disclosure.

FIG. 4A exhibits a representative structure before compression and welding according to one embodiment of the present disclosure.

FIG. 4B shows a representative structure after welding with an external compression according to one embodiment of the present disclosure.

FIG. 4C shows a representative cell structure according to another embodiment of the present disclosure.

FIG. 4D shows the structure of the representative cell structure of FIG. 4C after welding with an external compression according to one embodiment of the present disclosure.

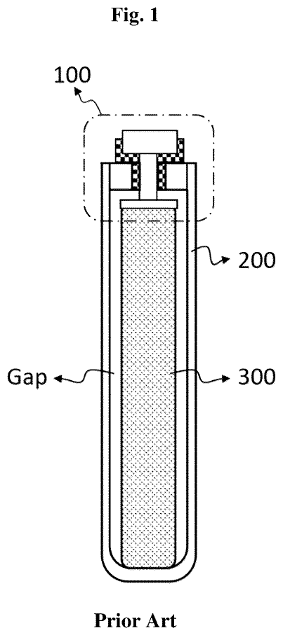

### DETAILED DESCRIPTION OF THE DISCLOSURE

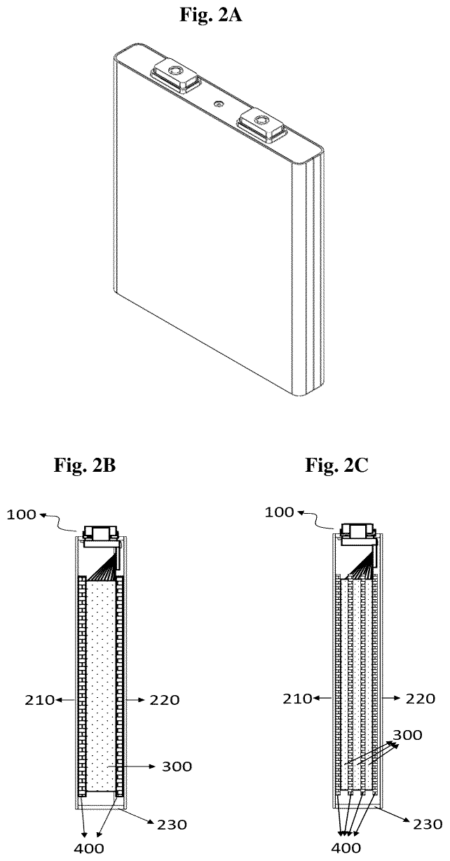

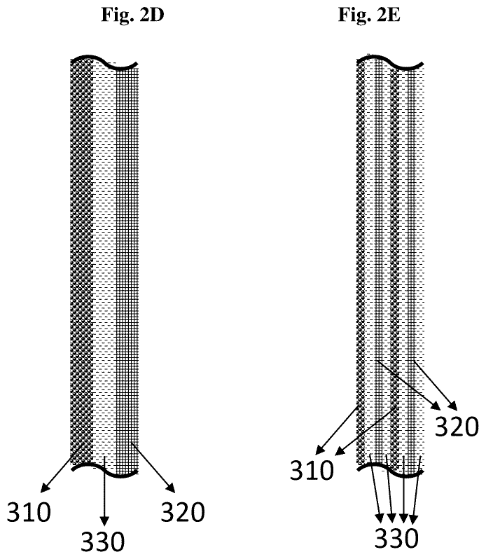

The present disclosure provides a new cell assembly for an all solid-state prismatic cell. As exemplarily shown in FIG. 2B, a housing (alternatively housing can) comprises a first plate (210) (either the front or rear plate) and a second plate (220) (either the rear or front plate), a bottom plate (230) and a lid-assembly (100) enveloping the electrode/electrolyte sheet or sheets (300). Elastic bodies (400) fill the gap between the internal wall of the housing can and the electrode/electrolyte sheet(s) (300). The elastic bodies (400) are placed between the front internal wall of the housing and the electrode/electrolyte sheet(s) (300) and between the rear internal wall of the housing can and the electrode/electrolyte sheet(s) (300). As shown in FIG. 2C, one or more elastic bodies (400) are sandwiched within electrode/electrolyte sheets (300) according to one embodiment of the present disclosure. FIG. 2D shows an electrode/electrolyte sheet (300) comprising a cathode layer (310), a solid-state electrolyte layer (330) and an anode layer (320) according to one embodiment of the present disclosure. FIG. 2E shows a set of electrode/electrolyte sheet(s) (300) each comprising multiple cathode layers (310), multiple solid-state electrolyte layers (330) and multiple anode layers (320) according to one embodiment of the present disclosure.

As shown for example in FIGS. 2A-2C, in some embodiments the prismatic cell assembly may include: a housing; one or more stacks (300) of sheets (or layers) each comprising an electrode layer and a solid-state electrolyte layer; and a pre-deformed elastic body (400). In some embodiments, pre-deformed elastic body (400) may be placed between the internal wall of the housing and the top or bottom of one of the stacks sheets as shown in FIG. 2B and/or sandwiched within two adjacent stacks as shown in FIG. 2C. The pre-deformed elastic body (400) exerts an internal compression on or among the stacked sheets in the absence of an external force on the housing, for example without the application of external forces on the housing post-manufacture of the prismatic cell assembly. In one embodiment as shown for example in FIG. 2B, the housing is formed by joining a first plate (210) and a second plate (220).

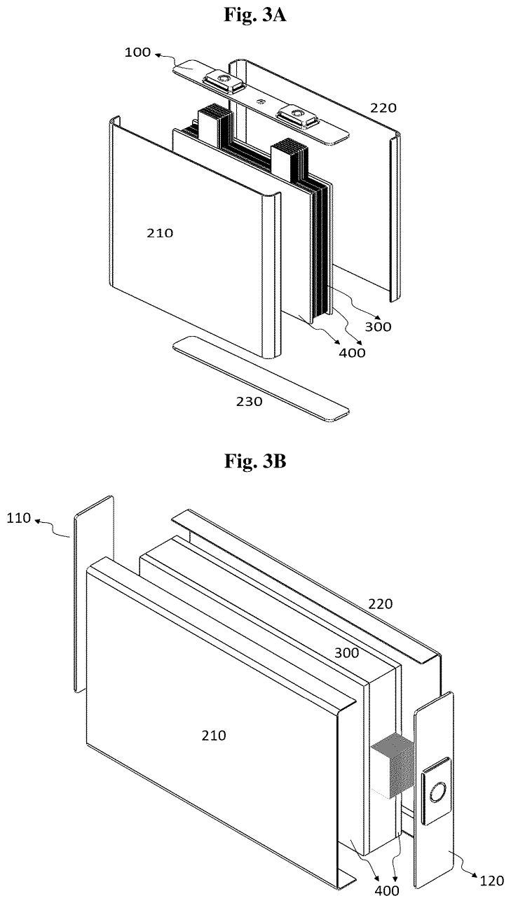

In one embodiment, the first and second plates are joined via a laser welding. FIG. 3A shows a typical cell assembly, in which a first plate (210) and a second plate (220) accommodate electrode with elastic bodies placed between the first or second plate and the electrode while the edges of the first plate are aligned with the edges of the second plate. After an external compression is loaded, the edges of the first and second plates are approached to each other and subsequently welded together to form a battery case with two openings sealed with a bottom plate (230) and a lid-assembly (100). FIG. 3B shows a representative cell assembly, in which a first plate (210) and a second plate (220) are assembled in cell thickness direction. The lid-assembly (100) comprises a positive lid-assembly (120) and a negative lid-assembly (110) on both side directions as shown therein.

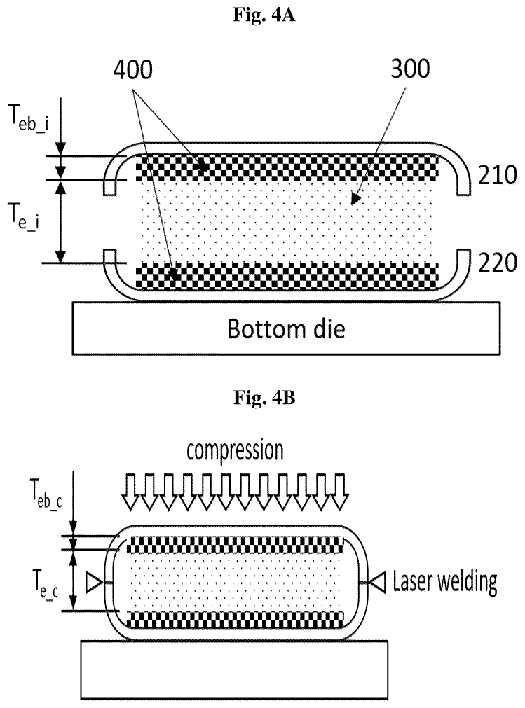

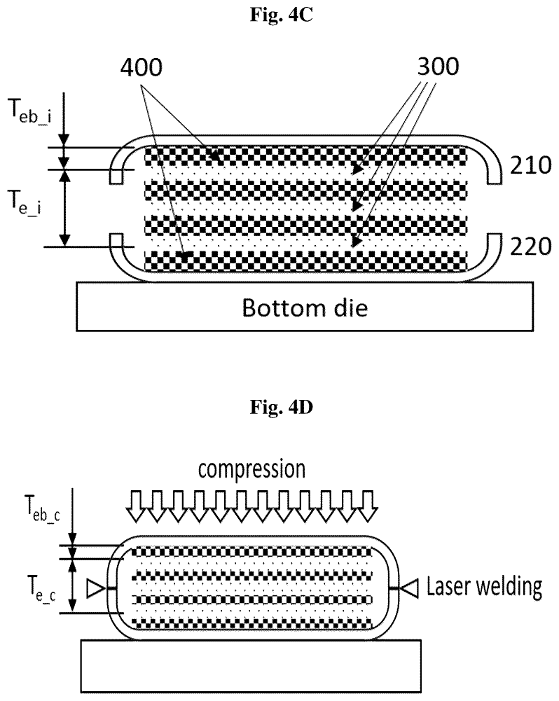

As shown in FIG. 4A, a representative structure before compression and welding comprises the elastic body (400) and the electrode/electrolyte sheet (300) with an initial thickness of T_{eb_i} and T_{e_i}, respectively. After the first and second plates are joined by for example a welding, as shown in FIG. 4B, the thicknesses of the elastic body (400) and electrode/electrolyte sheet (300) are decreased from T_{eb_i} to T_{eb_c} and from T_{e_i}; to T_{e_c}, respectively. FIG. 4C shows a representative cell structure in which another two elastic bodies are sandwiched within the electrode/electrolyte sheets (300).

In another aspect, the present disclosure provides a new cell assembly including a first plate (210), which can be the front or rear plate; a rear plate (220), which can be either the front or rear plate; one or more stacks (300) of sheets each stack comprising a solid-state electrolyte layer and an electrode layer; and an elastic body (400). The elastic body may be placed between either plate and the top or bottom of one of the stacks or sandwiched between two adjacent stacks. The first and second plates are joined together while an external compression is applied and maintained among the first plate, the stacks and the second plate, thereby forming a housing accommodating the stacks of sheets. The application of pressure deforms the shape of the elastic body into a pre-deformed elastic body. After the housing is formed, the pressurized pre-deformed elastic bodies exert an internal compression force on or among the stacks of sheets even after the external compression force is removed. In one embodiment, the elastic body or bodies are placed between adjacent cells. In one embodiment, the elastic body or bodies are placed between the external walls of adjacent cells.

In some embodiments, the first and second plates are joined by welding, adhesive bonding, screws, nuts, bolts, or any combination thereof. In one embodiment, the first and second plates are joined via a welding such as laser welding.

In some embodiments, when the first plate (210) and second plate (220) are joined the housing has opposing side walls with two ends formed by the first and second plates and the opposing side walls form an opening at each end. In some embodiments, the opening is covered/sealed by a lid, such as lid-assembly (100) and bottom plate (230).

In one embodiment, the first and second plates are independently made of a metal. In one embodiment, the metal includes without limitation Al, Mg, Ti, steel and alloys containing any of the same. In one embodiment, the housing is a hard-case housing.

In one embodiment, the first plate and second plate have a thickness ranging from 0.5 mm to 3.0 mm.

In some embodiments, as shown for example in FIG. 2D the one or more stacks (300) may include a cathode layer (310), a solid-state electrolyte layer (330), and an anode layer (320). In one embodiment, the electrode layer in stack (300) is a cathode layer. In some embodiments, the electrode layer in stack (300) is an anode layer. In some embodiments, a stack includes an electrolyte layer sandwiched between a cathode layer and an anode layer.

In one embodiment, the solid-state electrolyte includes without limitation a sulfide-based solid electrolyte material. The sulfide-based solid electrolyte material comprises, for example, Li₂S—P₂S₅, Li₂S—P₂S₅—LiX, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZnₘSₙ, Li₂S—GeS₂, Li₂S—SiS₂—Li₃PO₄, and Li₂S—SiS₂—LiₚMO_{q}, wherein X is a halogen element, e.g., bromine(Br), iodine (I) or chlorine (Cl), m and n are positive numbers, and Z is one of germanium (Ge), zinc (Zn), and gallium (Ga), p and q are positive numbers, and M is one of phosphorus (P), silicon (Si), germanium (Ge), boron (B), aluminum (Al), gallium (Ga), and indium (In), or the like. In this regard, the sulfide-based solid electrolyte material is prepared by treating a starting material (e.g., Li₂S, P₂S₅, or the like) by a metal quenching method, a mechanical milling method, or the like. In addition, another heat treatment may be performed thereafter. The solid electrolyte may be amorphous, crystalline, or in a mixed form.

In one embodiment, the raw material for the cathode active material is not particularly limited. In one embodiment, the raw material covers any CAM that is applicable to the all-solid-state lithium ion secondary battery. The raw materials for CAM include but are not limited to lithium cobaltate (LiCoO₂), lithium nickelate (LiNiO₂), lithium manganate (LiMn₂O₄), a different element-substituted Li—Mn spinel of the composition represented by Li₁₊ₓNi_{1/3}Mn_{1/3}Co_{1/3}O₂, Li₁₊ₓMn_{2-x-y}M_{y}O₄ (where M is one or more elements selected from Al, Mg, Co, Fe, Ni and Zn), lithium titanate (LiₓTiO_{y}) and lithium metal phosphate (LiMPO₄, M=Fe, Mn, Co, Ni, etc.). The cathode active material may include a coating layer. In one embodiment, the coating layer is lithium ion conductive. In one embodiment, the coating layer has a lithium-ion conductivity of no less than 1.0×10⁻⁸ mS/cm. The substance includes but is not limited to, LiNbO₃, Li₄Ti₅O₁₂ and Li₃PO₄. The form of the cathode active material is not particularly limited. It may be a film form or particle form. The anode may include an anode current collector and an anode active material on the current collector. In one embodiment, the anode comprises an anode current collector and an anode active material layer on the anode current collector. The anode current collector may comprise a material that is not reactive with lithium, i.e., does not form either an alloy or a compound with lithium. A suitable material for the anode current collector may be, for example, Cu, stainless steel, Ti, Fe, Co, Ni, or a combination comprising at least one of the foregoing. The anode current collector may comprise a single type of metal, an alloy of two or more metals, and may optionally comprise a coating on the metal. The shape of the anode current collector is not specifically limited, the anode current collector may be rectilinear or curvilinear, and the anode current collector may be, for example, in the form of a plate or foil. In an embodiment, the anode current collector may be in the form of a clad foil. Examples of the element that is alloyable with lithium include gold (Au), silver (Ag), zinc (Zn), tin (Sn), indium (In), silicon (Si), aluminum (Al), and bismuth (Bi).

In one embodiment, the stacks of sheets do not include any separators. In one embodiment, the stacks of sheets have a thickness in a range from 5.0 to 50.0 mm In one embodiment, the stacked sheets have a thickness in a range from 1 mm to 100 mm, from 2 mm to 100 mm, from 5 mm to 100 mm, from 10 mm to 100mm, from 20 to 100 mm, from 1 mm to 75 mm, from 2 mm to 75 mm, from 5 mm to 75 mm, from 10 mm to 75 mm, from 20 to 75 mm, from 1 mm to 50 mm, from 2 mm to 50 mm, from 5 mm to 50 mm, from 10 mm to 50mm, from 20 to 50 mm, from 1 mm to 25 mm, from 2 mm to 25 mm, from 5 mm to 25 mm, from 10 mm to 25 mm, and any and all of the ranges and subranges therebetween.

In one embodiment, the internal compression exerted by the pre-deformed elastic bodies leads to a compression pressure of 0.01 MPa to 10 MPa on or among the one or more stacked sheets. In one embodiment, the internal compression pressure ranges from 0.01 MPa to 8 MPa, from 0.01 MPa to 7 MPa, from 0.01 MPa to 6 MPa, from 0.01 MPa to 5 MPa, from 0.01 MPa to 4 MPa, from 0.01 MPa to 3 MPa, from 0.01 MPa to 2 MPa, from 0.01 MPa to 1 MPa, from 0.01 MPa to 0.75MPa, from 0.01 MPa to 0.5 MPa, from 0.01 MPa to 0.25 MPa, from 0.02 MPa to 10 MPa, from 0.05 MPa to 10 MPa, from 0.1MPa to 10 MPa, from 0.2 MPa to 10 MPa, from 0.5 MPa to 10 MPa, from 1.0 MPa to 10 MPa, from 2.0 MPa to 10 MPa, from 0.02 MPa to 5 MPa, from 0.05 MPa to 5 MPa, from 0.1 MPa to 5 MPa, from 0.2 MPa to 5 MPa, from 0.5 MPa to 5 MPa, from 1.0 MPa to 5 MPa, from 2.0 MPa to 5 MPa, from 0.01 MPa to 2.5 MPa from 0.02 MPa to 2.5 MPa, from 0.05 MPa to 2.5 MPa, from 0.1 MPa to 2.5 MPa, from 0.2 MPa to 2.5 MPa, from 0.5 MPa to 2.5 MPa, from 1.0 MPa to 2.5 MPa, and any and all ranges and subranges therebetween.

In some embodiments, the elastic body or bodes are made of one or more compressible materials including polymeric compressible material such as one fabricated of polymer foam, where the base material is a thermoplastic elastomer (TPE), such as thermoplastic urethane elastomer, thermoplastic polyester, or thermoplastic olefin. The polymeric foam may also be manufactured with an elastomeric silicone rubber, or one of the elastomeric natural or synthetic rubbers, such as ethylene propylene diene monomer (EPDM), styrene-butadiene rubber (SBR) or butyl rubber (BR). The porous foam structure may consist of closed cells or a mixture of open and closed cells.

In some embodiments, the combination of porosity, density, and/or thickness may contribute to the mechanical properties of the compressible materials. In some embodiments, the density of the elastic body may be in a range from 0.3 g/cm³ to 0.8 g/cm³ , 0.3 g/cm³ to 0.75 g/cm³, 0.3 g/cm³ to 0.7 g/cm³ , 0.3 g/cm³ to 0.65 g/cm³, 0.3 g/cm³ to 0.6 g/cm³, 0.3 g/cm³ to 0.55 g/cm³ , 0.3 g/cm³ to 0.5 g/cm³, 0.3 g/cm³ to 0.45 g/cm³ , 0.3 g/cm³ to 0.4 g/cm³, 0.35 g/cm³ to 0.8 g/cm³, 0.35 g/cm³ to 0.75 g/cm³, 0.35 g/cm³ to 0.7 g/cm³, 0.35 g/cm³ to 0.65 g/cm³, 0.35 g/cm³ to 0.6 g/cm³ , 0.35 g/cm³ to 0.55 g/cm³ , 0.35 g/cm³ to 0.5 g/cm³, 0.35 g/cm³ to 0.45 g/cm³, 0.35 g/cm³ to 0.4 g/cm³, 0.4 g/cm³ to 0.8 g/cm³, 0.4 g/cm³ to 0.75 g/cm³, 0.4 g/cm³ to 0.7 g/cm³ , 0.4 g/cm³ to 0.65 g/cm³, 0.4 g/cm³ to 0.6 g/cm³, 0.4 g/cm³ to 0.55 g/cm³, 0.4 g/cm³ to 0.5 g/cm³ , 0.4 g/cm³ to 0.45 g/cm³, 0.45 g/cm³ to 0.8 g/cm³, 0.45 g/cm³ to 0.75 g/cm³, 0.45 g/cm³ to 0.7 g/cm³, 0.45 g/cm³ to 0.65 g/cm³, 0.45 g/cm³ to 0.6 g/cm³, 0.45 g/cm³ to 0.55 g/cm³, 0.45 g/cm³ to 0.5 g/cm³, 0.5 g/cm³ to 0.8 g/cm³, 0.5 g/cm³ to 0.75 g/cm³, 0.5 g/cm³ to 0.7 g/cm³, 0.5 g/cm³ to 0.65 g/cm³, 0.5 g/cm³ to 0.6 g/cm³, 0.5 g/cm³ to 0.55 g/cm³, and all ranges and subranges therebetween. In some embodiments, the porosity of the elastic body may be in a range from 20% to 70%, 20% to 65%, 20% to 60%, 20% to 55%, 20% to 50%, 20% to 45%, 20% to 40%, 20% to 35%, 20% to 30%, 25% to 70%, 25% to 65%, 25% to 60%, 25% to 55%, 25% to 50%, 25% to 45%, 25% to 40%, 25% to 35%, 30% to 70%, 30% to 65%, 30% to 60%, 30% to 55%, 30% to 50%, 30% to 45%, 30% to 40%, 35% to 70%, 35% to 65%, 35% to 60%, 35% to 55%, 35% to 50%, 35% to 45%, 40% to 70%, 40% to 65%, 40% to 60%, 40% to 55%, 40% to 50%, 45% to 70%, 45% to 65%, 45% to 60%, 45% to 55%, or any and all ranges and subranges therebetween. In some embodiments, the thickness of the elastic body may be in a range from 1/16 inch to ½ inch, 1/16 inch to ¼ inch, ⅛ inch to ½ inch, ⅛ inch to ¼ inch, ¼ inch to ½ inch, or any and all ranges and subranges therebetween. In some embodiments, the compressible material is chosen so that after removal of the external compression, the elastic body exerts a sufficient compression pressure on the stacks. In some embodiments, the compressible material is chosen so that after removal of the external compression, the elastic body exerts a compression pressure on the stacks in a uniform manner

In one aspect, the present disclosure discloses a method of assembling a prismatic cell comprising a battery case with an elastic body.

In one embodiment, the assembling method includes the following steps as shown for example in FIGS. 4A-4D:
1) placing one or more stacks (300) and an elastic body (400) between a first plate (210) and a second plate (220), wherein each stack comprises a solid-state electrolyte layer, a cathode layer and an anode layer, and wherein a first edge of the first plate is aligned with a first edge of the second plate and a second edge of the first plate is aligned with a second edge of the second plate,
2) applying and maintaining an external compression on the first and second plates, thereby deforming the shape of the elastic body into a pre-deformed elastic body,
3) joining the first and second edges of the first plate to the first and second edges of the second plate, respectively, while maintaining the external compression thereby forming a housing accommodating the one or more stacked stacks and the pre-deformed elastic body, and
4) removing the external compression, wherein after the external compression is removed, the pre-deformed elastic body exerts an internal compression on or among the one or more stacks within the housing.

In one embodiment, an external compression is applied to the first or second plate which can be either the front or rear plate. In one embodiment, one plate is placed on a support base such as a bottom die as shown in FIG. 4A. In some embodiments, during application of the external compression the pre-deformed elastic body exerts an average normal compression pressure within the cell and once the external compression is removed the pre-deformed elastic body exerts an average normal internal compression pressure which is at least 50%, at least 55%, at least 60%, at least 65%, at least 67%, at least 70%, at least 72%, at least 75%, at least 77%, at least 80%, at least 82%, at least 85% or at least 90% of an average normal compression pressure with the external compression applied. In one embodiment, the first and second plates are joined by welding, adhesive bonding, screws, nuts, bolts, or any combination thereof. In one embodiment, the welding is conducted via a laser welding as shown in FIG. 4B. In one embodiment, the welding connection between the first and second plates is subject to a cooling process before removing the external compression.

In some embodiments, the first and second plates as joined is a side wall of the housing accommodating the stacked sheet(s). In some embodiments, the housing comprises one or two openings. In some embodiments, the opening is covered by a lid or lid-assembly, such as lid-assembly (100) or bottom plate (230).

In one embodiment, the internal compression is a force leading to a compression pressure on or among the one or more stacked sheets. A minimum compression pressure of on the first plate or second plate is required to contact electrode/electrolyte layers in all-solid-state batteries. In some embodiments, the minimum compression pressure is in a range from 0.02 MPa to 1.0 MPa, from 0.05 MPa to 1.0 MPa, from 0.1 MPa to 1.0 MPa, from 0.2 MPa to 1.0 MPa, from 0. 5 MPa to 1.0 MPa, and any and all ranges and subranges therebetween. A compression pressure may vary according to the number, thickness and material of layers constituting the electrode. In one embodiment, the favorable compression pressure is 0.05 MPa. In one embodiment, the favorable compression pressure is 0.1 MPa. In one embodiment, the minimum compression pressure is 0.25 MPa. In one embodiment, the favorable compression pressure is 0.5 MPa. In one embodiment, the compression pressure shall not exceed a certain level to maintain the integrity of the electrode and electrolyte materials. In one embodiment, the compression pressure is no higher than 20 MPa. In one embodiment, the compression pressure is no higher than 10 MPa. In one embodiment, the compression pressure is no higher than 7.5MPa. In one embodiment, the compression pressure is no higher than 5 MPa. In one embodiment, the compression pressure is no higher than 2.5 MPa.

It is to be noted that the transitional term “comprising”, which is synonymous with “including”, “containing” or “characterized by”, is inclusive or open-ended and does not exclude additional, un-recited elements or method steps.

In a first aspect of the present disclosure, a prismatic cell assembly comprises:
1) a housing; and
2) one or more stacks in the housing, each stack comprising a solid-state electrolyte layer, a cathode layer and an anode layer; and
3) a pre-deformed elastic body positioned inside the housing such that the pre-deformed elastic body exerts an internal compression on or among the one or more stacked sheets without the application of external forces on the housing post-manufacture of the prismatic cell assembly.

In a second aspect according to the first aspect of the present disclosure, the housing comprises a first plate and a second plate joined via edges thereof.

In a third aspect according to the second aspect, the edges of the first and second plates meet with each other either vertically or horizontally

In a fourth aspect according to the second aspect, the first and second plates are joined together by a weld.

In a fifth aspect according to the second aspect, the housing comprises opposing side walls with two ends formed by the joining of the first and second plates, wherein the opposing side walls form an opening at each end.

In a sixth aspect according to the fifth aspect, the cell assembly further comprises a lid sealing each of the openings.

In a seventh aspect according to the first aspect, the pre-deformed elastic body is positioned between an internal wall of the housing and a surface of one of the one or more stacks.

In an eighth aspect according to the first aspect, the pre-deformed elastic body is positioned between two of the one or more stacks.

In a ninth aspect according to the first aspect, the internal compression leads to a compression pressure of 0.01 to 10 MPa on or among the one or more stacked sheets

In a tenth aspect according to the first aspect, the housing is made of Al, Mg, Ti, steel, or an alloy comprising at least one thereof.

In an eleventh aspect, the present disclosure provides an all solid-state battery comprising the cell assembly according to the first aspect.

In a twelfth aspect, the present disclosure provides a method of assembling a prismatic cell assembly. The method may comprise:
1) placing one or more stacks and an elastic body between a first plate and a second plate, wherein each stack comprises a solid-state electrolyte layer, a cathode layer and an anode layer, and wherein a first edge of the first plate is aligned with a first edge of the second plate and a second edge of the first plate is aligned with a second edge of the second plate;
2) applying and maintaining an external compression on the first and second plates, thereby deforming the shape of the elastic body into a pre-deformed elastic body;
3) joining the first and second edges of the first plate to the first and second edges of the second plate, respectively, while maintaining the external compression thereby forming a housing accommodating the one or more stacked stacks and the pre-deformed elastic body; and
4) removing the external compression, wherein after the external compression is removed, the pre-deformed elastic body exerts an internal compression on or among the one or more stacks within the housing.

In a thirteenth aspect according to the twelfth aspect, the first and second edges of the first plate and the first and second edges of the second plate are joined by a welding.

In a fourteenth aspect according to the thirteenth aspect, wherein the welding is a laser welding.

In a fifteenth aspect according to the twelfth aspect, the internal compression leads to a compression pressure of 0.01 to 10 MPa on or among the one or more stacks.

In a sixteenth aspect according to the twelfth aspect, before removing the compression, the housing is subjected to a cooling process.

In a seventeenth aspect according to the twelfth aspect, the pre-deformed elastic body is positioned between (i) one of the stacks and (ii) either the first or second plate.

In an eighteenth aspect according to the twelfth aspect, the pre-deformed elastic body is positioned between two of the one or more stacks.

We claim:

1. A prismatic cell assembly, comprising:
a. a housing;
b. one or more stacks in the housing, each stack comprising a solid-state electrolyte layer, a cathode layer and an anode layer; and
c. a pre-deformed elastic body positioned inside the housing such that the pre-deformed elastic body exerts an internal compression on or among the one or more stacked sheets without the application of external forces on the housing post-manufacture of the prismatic cell assembly.

2. The cell assembly of claim 1, wherein the housing comprises a first plate and a second plate joined via edges thereof.

3. The cell assembly of claim 2, wherein the edges of the first and second plates meet with each other either vertically or horizontally.

4. The cell assembly of claim 2, wherein the first and second plates are joined together by a weld.

5. The cell assembly of claim 2, wherein the housing comprises opposing side walls with two ends formed by the joining of the first and second plates, wherein the opposing side walls form an opening at each end.

6. The cell assembly of claim 5, further comprising a lid sealing each of the openings.

7. The cell assembly of claim 1, wherein the pre-deformed elastic body is positioned between an internal wall of the housing and a surface of one of the one or more stacks.

8. The cell assembly of claim 1, wherein the pre-deformed elastic body is positioned between two of the one or more stacks.

9. The cell assembly of claim 1, wherein the internal compression leads to a compression pressure of 0.01 to 10 MPa on or among the one or more stacked sheets.

10. The cell assembly of claim 1, wherein the housing is made of Al, Mg, Ti, steel, or an alloy comprising at least one thereof.

11. An all solid-state battery comprising the cell assembly of claim 1.

12. A method of assembling a prismatic cell assembly, comprising:
a. placing one or more stacks and an elastic body between a first plate and a second plate, wherein each stack comprises a solid-state electrolyte layer, a cathode layer and an anode layer, and wherein a first edge of the first plate is aligned with a first edge of the second plate and a second edge of the first plate is aligned with a second edge of the second plate;
b. applying and maintaining an external compression on the first and second plates, thereby deforming the shape of the elastic body into a pre-deformed elastic body;
c. joining the first and second edges of the first plate to the first and second edges of the second plate, respectively, while maintaining the external compression thereby forming a housing accommodating the one or more stacked stacks and the pre-deformed elastic body; and
d. removing the external compression, wherein after the external compression is removed, the pre-deformed elastic body exerts an internal compression on or among the one or more stacks within the housing.

13. The method of claim 12, wherein the first and second edges of the first plate and the first and second edges of the second plate are joined by a welding.

14. The method of claim 13, wherein the welding is a laser welding.

15. The method of claim 12, wherein the internal compression leads to a compression pressure of 0.01 to 10 MPa on or among the one or more stacks.

16. The method of claim 12, wherein before removing the compression, the housing is subjected to a cooling process.

17. The method of claim 12, wherein the pre-deformed elastic body is positioned between (i) one of the stacks and (ii) either the first or second plate.

18. The method of claim 12, wherein the pre-deformed elastic body is positioned between two of the one or more stacks.
